(19) United States
(12) Patent Application Publication
(10) Pub. No.: US 2015/0207130 A1
(43) Pub. Date: Jul. 23, 2015

(54) BATTERY COVER WITH ELECTRICAL DISCONNECT

(71) Applicant: Ford Global Technologies, LLC, Dearborn, MI (US)

(72) Inventors: Patrick Daniel MAGUIRE, Ann Arbor, MI (US); Philip Michael GONZALES, Dearborn, MI (US); Saravanan PARAMASIVAM, South Lyon, MI (US); Josephine S. LEE, Novi, MI (US)

(73) Assignee: Ford Global Technologies, LLC, Dearborn, MI (US)

(21) Appl. No.: 14/159,158

(22) Filed: Jan. 20, 2014

(51) Int. Cl. H01M 2/34; H01M 2/10

(52) U.S. Cl. CPC H01M 2/34; H01M 2/1083; H01M 2200/00; H01M 2220/20

(57) ABSTRACT

A traction battery includes a housing that has a tray and a cover, and a plurality of battery components supported by the tray and enclosed by the cover. A service disconnect base is disposed within the housing and is electrically connected with the components by a circuit. The housing includes an access panel with a service disconnect plug attached to the panel. The access panel is movable between open and closed positions. The service disconnect plug connects circuitry within the service disconnect base when the panel is in the closed position. The service disconnect plug is disconnected with the service disconnect base when the panel is in the open position to open the circuit.

### TECHNICAL FIELD

This disclosure relates to battery covers for electric vehicles to limit exposure to high voltage components.

### BACKGROUND

Vehicles such as battery-electric vehicles (BEVs), plug-in hybrid electric vehicles (PHEVs) or hybrid-electric vehicles (HEVs) contain a traction battery assembly to act as an energy source for the vehicle. The traction battery may include components and systems to assist in managing vehicle performance and operations. The traction battery may include high voltage components. Limiting exposure to the high voltage components may be advantageous.

### SUMMARY

In one embodiment, a traction battery comprises a housing including a tray and a cover and a plurality of battery components supported by the tray and enclosed by the cover. The housing includes an access panel having a closed position and an open position. A service disconnect base is disposed within the housing. A circuit electrically connects the components and the service disconnect base. A service disconnect plug is attached to the panel. The service disconnect plug connects circuitry within the service disconnect base when the panel is in the closed position. The service disconnect plug is disconnected with the service disconnect base when the panel is in the open position to open the circuit.

In another embodiment, a traction battery comprises a housing including a cover having a service disconnect plug fixedly attached thereto. A vehicle high-voltage cable is disposed within the housing. A service disconnect base is disposed within the housing and electrically connected to the cable via an electric circuit. The service disconnect base is configured to receive the plug. The cover, plug and base are arranged such that opening the cover opens the circuit and de-energizes the high-voltage cable.

In yet another embodiment, a traction battery comprises a tray and a battery cover cooperating with the tray to define a cavity. The battery cover includes a flexible portion. Circuitry including an electrical receptacle is disposed within the cavity. A conductive element is attached with the flexible portion and is configured to engage the electrical receptacle when the flexible portion is pushed into the cavity.

### BRIEF DESCRIPTION OF THE DRAWINGS

FIG. 1A is a side view, in cross-section, of a traction battery with the access panel in the closed position.

FIG. 1B is a side view, in cross-section, of the traction battery of FIG. 1A with the access panel in the open position.

FIG. 1C is a side view, in cross-section, of the traction battery of FIG. 1A with the cover removed.

FIG. 2 is a perspective view of a service disconnect switch.

FIG. 3 is an electrical schematic of circuitry associated with a disconnect switch.

FIG. 4 is an electrical schematic of alternative circuitry associated with a disconnect switch.

FIG. 5 is a side view, in cross-section, of another traction battery.

FIG. 6 is a perspective view of yet another traction battery.

FIG. 7 is a side view, in cross-section, of the traction battery of FIG. 6.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

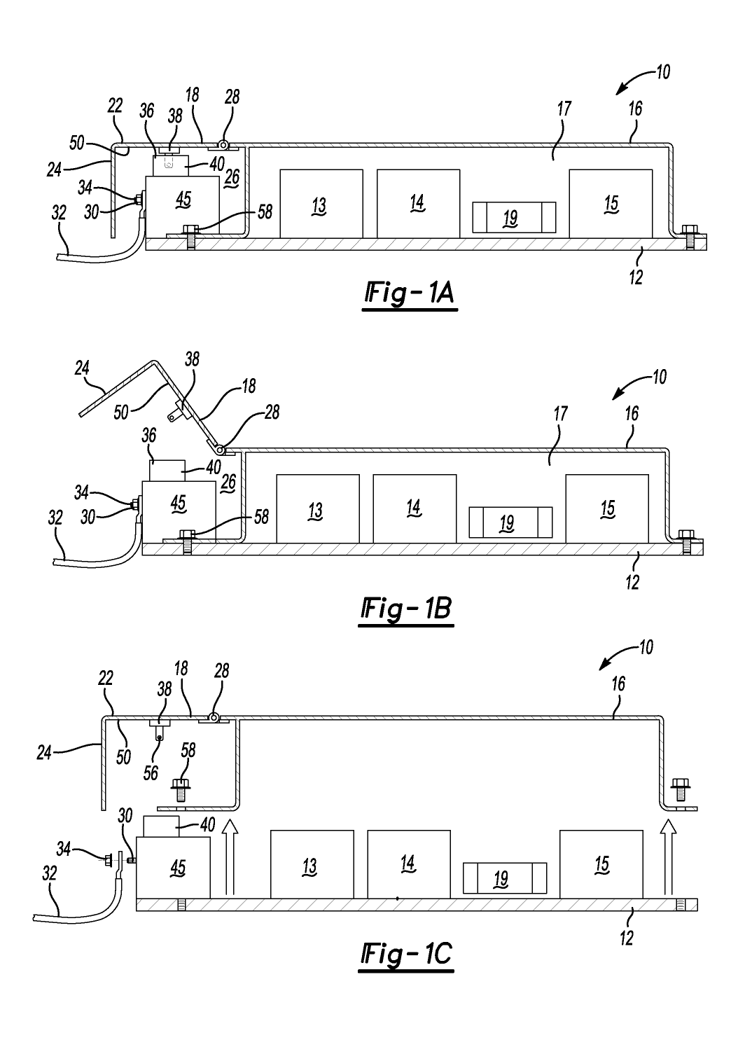

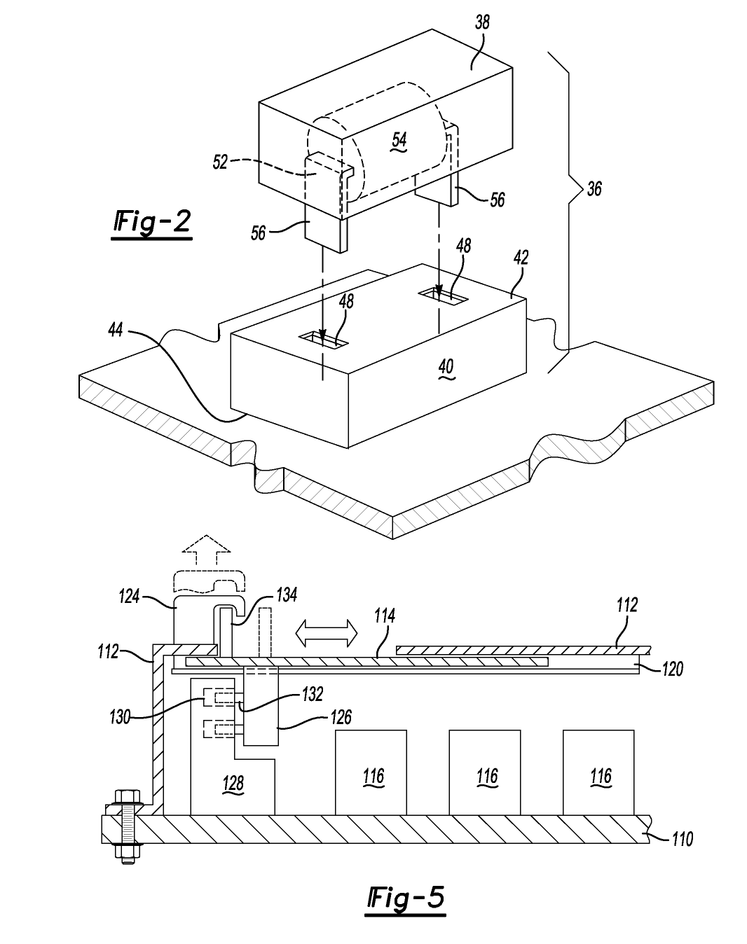

Referring to FIGS. 1A to 3, a traction battery assembly 10 is shown. The battery assembly 10 includes a tray 12 for supporting a plurality of battery components. The battery components may be serviceable components such as contactors 13, 14, 15, and resistors 19. Additionally, the battery components may be high voltage components. The battery components are electrically connected with circuitry 20 for electrically connecting with one or more power sources 46, such as a battery array. A removable cover 16 is attached to the tray 12 forming a chamber 17. The cover 16 and tray 12 may be attached by fasteners or other conventional means. The battery components are disposed within the chamber 17 when the cover 16 is installed on the tray 12. The cover 16 provides protection to the battery components and prevents unwanted human contact with the components. In some designs, the least one power source 46 may also be disposed within the chamber 17. In other designs, the power source 46 may be disposed in another chamber that may or may not be serviceable.

An access panel 18 is connected to the cover 16. The access panel 18 has a top panel 22, a front panel 24 and may have side panels (not shown). The access panel 18 cooperates with the tray 12 to form an enclosure 26. The top panel 22 is pivotally connected to the cover 16 via a hinge 28 such that the access panel 18 can rotate relative to the cover 16 between open and closed positions. FIG. 1A illustrates the access panel 18 in the closed position. FIG. 1B illustrates the access panel 18 in the open position. In the closed position, the access panel 18 limits access to the enclosure 26. In the open position, the access panel 18 allows access to enclosure 26. The hinge 28 may be a mechanical hinge or a living hinge. A main battery connection terminal 30 is disposed within the enclosure 26. The terminal 30 is electrically connected to the circuitry 20. The terminal 30 may be a threaded stud. A vehicle cable 32 is attached to the terminal 30 to electrically connect vehicle cable 32 to the circuitry 20. The vehicle cable 32 may include an eyelet received on the stud 30 and secured to the stud 30 with a nut 34. The vehicle cable 32 delivers power from the power source 46 to the electric motor (not shown) that propels the vehicle.

The battery assembly 10 includes a service disconnect 36. The service disconnect 36 acts as a kill-switch for the circuitry 20. The service disconnect 36 includes a service disconnect plug (SD plug) 38 and a service disconnect base (SD base) 40. The SD plug 38 is receivable within the SD base 40. The SD plug 38 can also be disconnected from the SD base 40. When the service disconnect 36 is disconnected, an open is created in the circuitry 20 to de-energize the circuitry 20.

The SD base 40 is disposed within the enclosure 26. The SD base has a bottom 44 and a top 42. The SD base 40 includes at least two female receptacles 48. The female receptacles 48 receive at least a portion of the SD plug 38 therein. The female receptacles 48 are an electrically conductive material and are electrically connected to the circuitry 20. The SD base 40 may be made of a non-conductive material, such as plastic. The SD base 40 is positioned with the bottom 44 attached to a riser 45 and the top 42 facing towards an inner surface 50 of the top panel 22. The riser 45 may be excluded. When the riser 45 is excluded the bottom 44 may be attached to the tray 12 or any component within the enclosure.

The SD plug 38 includes an electrically conductive member 52. The conductive member 52 may be a strip of metal, such as cooper or aluminum. The conductive member 52 may include a fuse 54. The conductive member 52 is partially received with the SD plug 38 and has two prongs 56 which protrude out of and extend away from the plug 38. The prongs 56 are received within the female receptacles 48 when the SD plug 38 and SD base 40 are connected. Inserting the prongs 56 into the receptacles 48 closes at least a portion of the circuitry 20.

The SD plug 38 is attached to the top panel inner surface 50 with the prongs 56 facing and aligned with the receptacles 48. The access panel 18, SD base 40 and SD plug 38 are arranged such that the SD base 40 and the SD plug 38 are connected when the access panel 18 is in the closed position and such that the SD base 40 and the SD plug 38 are disconnected when the access panel 18 is in the open position. The SD base 40 and the SD plug 38 may be inverted with the SD plug 38 disposed inside the enclosure 26 and the SD base 40 attached to the access panel 18.

Attaching the service disconnect 36 to the access panel ensures the service disconnect 36 will automatically de-energize the circuitry 20 when the access panel 18 is opened. As previously described, the cover 16 may be attached to the tray 12 by fasteners, such as bolts. At least one of the fasteners, fastener 58, is in the enclosure 26. This forces a user to open the access panel 18 in order to access the fastener 58. Thus, the cover 16 cannot be removed without opening the access panel 18 and de-energizing the circuitry 20. The access panel 18 may be attached to the cover 16. Attachment of the access panel 18 to the cover 16 prevents a user from removing the cover 16 and then reconnecting the service disconnect 36 with the cover 16 removed from the tray 12. In the arrangement shown in FIG. 1, the user must reinstall the cover 16 on the tray 12 in order for the service disconnect 36 to be reconnected.

The embodiment described above described may allow for a simple bolt-on connection between the terminal 30 and the main vehicle cable 32. The bolt-on connection is a simple and inexpensive means of attachment that may reduce cost and increase efficiency in the manufacturing process. Bolt-on terminals are conductive and may discharge electricity when touched if the circuitry 20 is energized. The design shown in FIG. 1 reduces the likelihood of exposing an energized terminal by placing the terminal 30 inside the enclosure 26. Thus, the access panel 18 must be opened and the circuitry 20 de-energized in order to access the terminal 30.

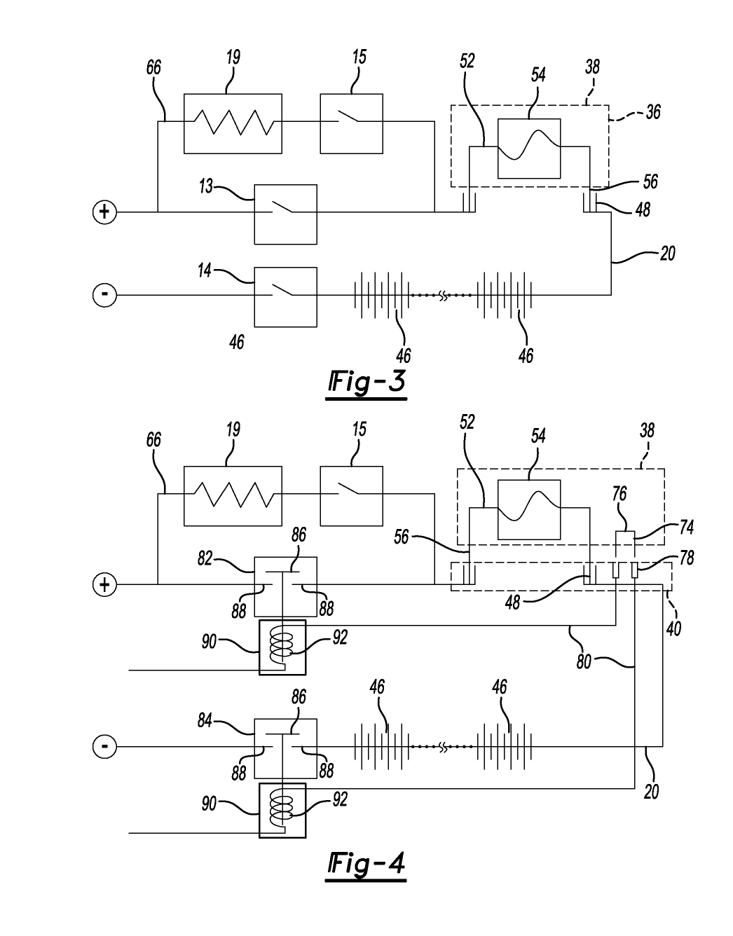

FIG. 3 illustrates the circuitry 20. The circuitry 20 is electrically connected with a power source 46. The power source 46 may be a plurality of battery cells arranged in an array. The power source 46 provides energy to the circuitry 20 and is used for powering the electric motor. The circuitry 20 also includes a first contactor 13 and a second contactor 14. The contactors 13, 14 are switches which open and close the circuitry 20. A pre-charge circuit 66 may be included in the circuitry 20. The pre-charge circuit 66 includes a resistor 19 and a pre-charge contactor 15. The circuitry 20 also includes a service disconnect 36. The service disconnect base 40 includes the female receptacles 48 which are electrically connected with the circuitry 20. The service disconnect 36 is a switch and creates an open in the circuit when the service disconnect plug 38 is removed from the circuitry 20. The service disconnect plug 38 includes prongs 56 which are received within the female receptacles 48. When the prongs 56 are received within the female receptacles 48 the service disconnect 36 is closed and the open is closed. Removing the prongs 56 from the receptacles 48 de-energizes the circuitry 20.

Referring to FIGS. 1A to 1C and 4, an alternative embodiment is shown that includes an interlock switch 74. The interlock switch 74 is an additional kill-switch. The interlock switch 74 is electrically connected to circuitry 20 with interlock circuitry 80. The interlock circuitry 80 is a low-voltage circuit connecting the interlock switch 74 with actuators 90 that open and/or close the contactors 82, 84. When the interlock switch 74 is open, the contactors 82, 84 are also open and the circuitry 20 is de-energized. The interlock switch 74 includes an interlock connector 76 and an interlock receptacle 78. The interlock connector 76 may be partially embedded in the service disconnect plug 38 and may project outwardly from the service disconnect plug 38. The interlock receptacles 78 may be disposed within the service disconnect base 40. The interlock receptacles 78 receive the interlock connector 76 when the interlock switch 74 is closed.

The interlock switch 74, similar to the service disconnect 36, opens when the access panel 18 is moved from the closed position to the open position. Moving the access panel 18 from the closed position to the open position removes the interlock connector 76 from the interlock receptacles 78, which opens the interlock switch 74. The interlock switch 74 may be arranged to open before the service disconnect 36 opens. Opening the interlock switch 74 first de-energizes the circuitry 20 prior to the removal of the SD plug 38 from the SD base 40. This prevents arcing between the prongs 56 and the female receptacles 48 when the SD plug 38 is removed from the SD base 40. Having both the interlock switch 74 and the service disconnect 36 also provides a redundancy in the rare event that one of them fails.

Each of the contactors 82, 84 includes a movable plunger 86 and contacts 88. The contactors 82, 84 are closed when the plunger 86 and contacts 88 are touching and open when not touching. The plunger 86 is spring biased to an open (de-energized) position. The plunger 86 is controlled by an actuator 90. The actuator 90 is electrically connected with the interlock circuitry 80 and is controlled by the interlock switch 74. The actuator 90 is configured to overcome the spring bias and pull the plunger 86 against the contacts 88 when the interlock switch 74 is closed. The actuator 90 may include a wire coil 92 wrapped around a shaft of the plunger 86. The wire coil 92 magnetically pulls the plunger 86 against the contacts 88 in response to a voltage signal from the closed interlock switch 74. Alternatively, the interlock circuitry 80 may be used to monitor the opening of at least one cover and connector but does not necessarily provide the current that drives the contactors to be held closed directly. In this configuration, the contactors 82, 84 may be opened and closed by a component other than the interlock circuitry 80. These examples are not limiting and a person having ordinary skill in the will appreciate other configurations.

FIG. 1 illustrates the access panel 18 pivotally attached to the cover 16 via a hinge 28. However, the present disclosure contemplates additional connection methods for attaching the cover 16 and access panel 18. FIG. 5 illustrates an embodiment with a sliding access panel. The tray 110 supports a plurality of battery components 116. A battery cover 112 is disposed over the battery components 116 and is attached to the tray 110. The battery cover 112 may be attached to the tray 110 by fasteners such as bolts. An access panel 114 is provided in the cover 112. The access panel 114 is slidably attached to the cover 112. The cover 112 includes L-arms 120 forming channels for receiving a portion of the access panel 114. The access panel 114 slides along the L-arms 120 when the access panel 114 moves between the open and closed positions. A handle 134 is attached to the access panel 114 to facilitate sliding the access panel 114 relative to the cover 112. A clip 124 is affixed to the cover 112 and cooperates with the handle 134 to hold the access panel 114 in the closed position. A user can flex the clip 124 to release the handle 134 from the clip 124 and slide the access panel 114 open.

The service disconnect plug 126 is attached to an inner side of the access panel 114. The SD base 128 is disposed inside the cover 112 proximate the access panel 114. The conductive member 132 cooperates with the female receptacles 130 in the SD base 128 as previously described above. When the access panel 114 slides relative to the cover 112 in the open direction, the conductive member 132 is disconnected from the female receptacles 130 and the circuitry 20 is de-energized. Similar to the embodiment of FIG. 1, one of the fasteners for securing the cover 112 to the tray 110 may be located under the access panel 114 such that the cover 112 cannot be removed from the tray 110 without opening the access panel 114 and de-energizing the circuitry 20. While not shown in FIG. 4, an interlock switch similar to that of FIG. 3 may be incorporated into the sliding access panel embodiment of FIG. 4.

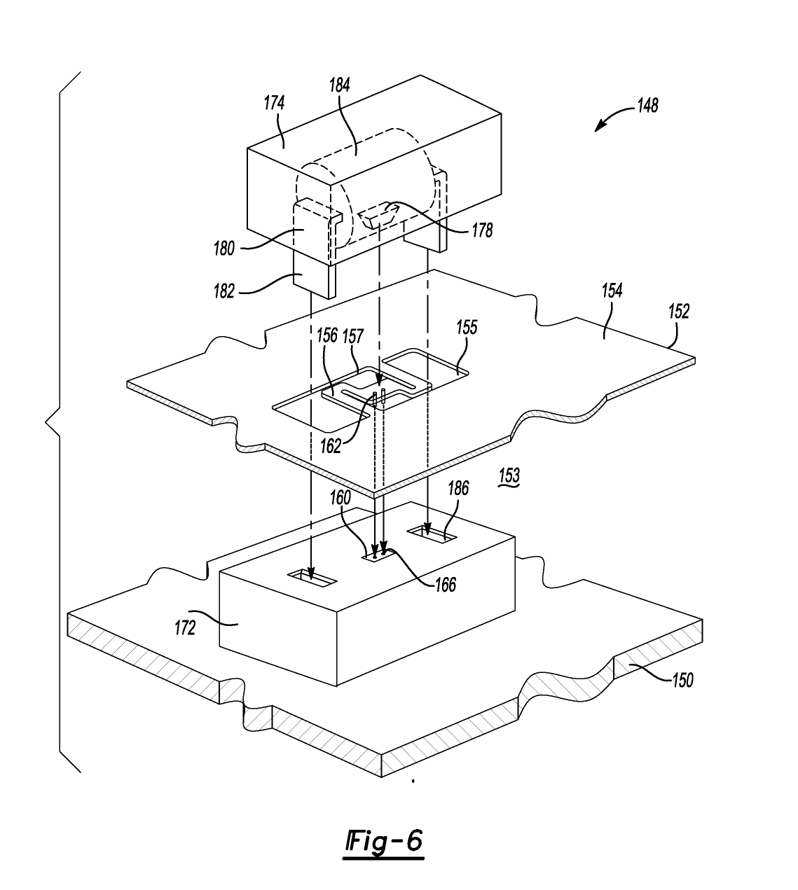

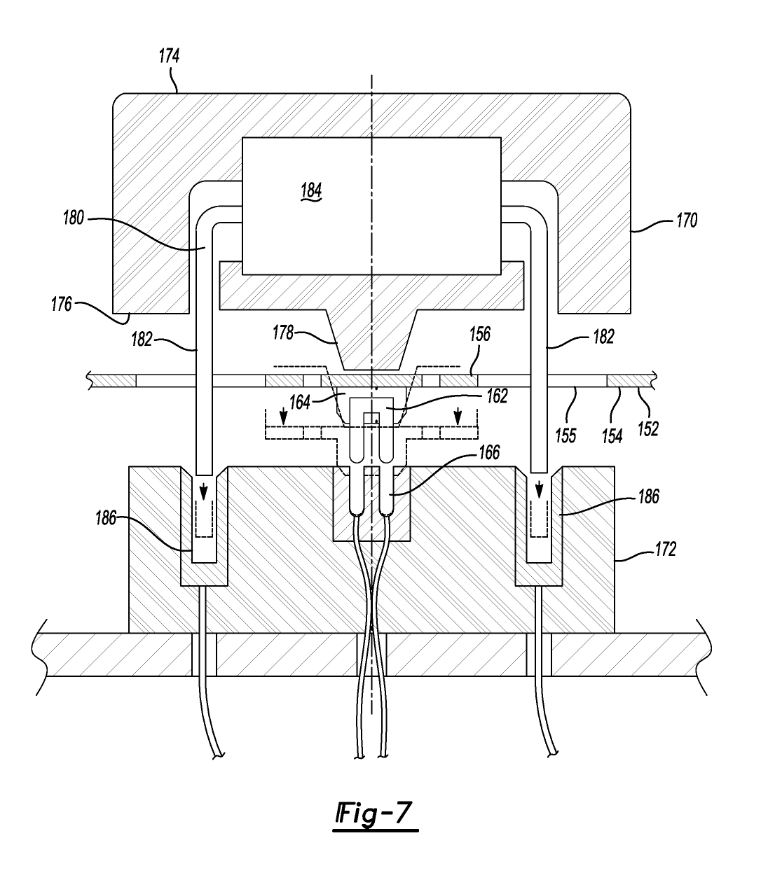

Referring to FIGS. 6 and 7, a traction battery assembly 148 of an alternative embodiment is shown. The traction battery assembly 148 includes a tray 150 and a cover 152. The tray 150 and cover 152 cooperate to define a cavity 153. The tray 150 may support a plurality of battery components (not shown) disposed within the cavity 153. The battery components are similar to the battery components previously described and may be serviceable components and/or high-voltage components. The cover 152 includes a cover top surface 154. The cover 152 may include a flexible portion 156. For example, a flexible portion 156 is received within an aperture 155. The flexible portion 156 is biased to sit substantially flush with the top 154. The flexible portion 156 may be a spring component that is attached to the top 154 at the aperture side edges 157. The flexible portion 156 may be made of spring steel or a flexible plastic. Alternatively, the flexible portion 156 may be integral with the top 154. The flexible portion 156 is configured to be depressed into the cavity 153 when a downward force is applied.

The fraction battery assembly 148 includes an interlock 160 that is electrically connected with the circuitry 20 via interlock circuitry 80. The interlock 160 includes a conductive element 162 and electrical receptacles 166. The interlock 160 opens the contactors 82, 84 when the conductive element 162 is removed from the electric receptacle 166 to de-energize the circuitry 20 as previously described above. The conductive element 162 is attached to the flexible portion 156 by a retainer 164. The retainer 164 is preferably made from a nonconductive material to insulate the cover 152 from the interlock circuitry 80. The electrical receptacle 166 is disposed inside the cavity 153. The electrical receptacle 166 is positioned to sit just below an inner surface of the top 154. The electrical receptacle 166 is aligned with the conductive element 162 such that the conductive element 162 will be received within the receptacle 166 when the flexible portion 156 is pushed towards the electrical receptacle 166.

The traction battery assembly 148 may also include a service disconnect 170. The service disconnect 170 includes a SD base 172 disposed within the cavity 153 and configured to sit just below the top 154. The SD base 172 includes female receptacles 186 that face towards the top 154. The female receptacles 186 are electrically connected with the circuitry 20 as previously described. The electrical receptacles 166 may be disposed within the SD base 172. The service disconnect 170 also includes a SD plug 174. The SD plug 174 includes a conductive member 180 partially received within the plug 174. The conductive member 180 has a fuse 184 and two prongs 182 that project outwardly from the SD plug 174. The prongs 182 are received within the female receptacles 186 when the service disconnect 170 is connected. The circuitry 20 is de-energized when the prongs 182 are removed from the female receptacles 186 as previously described. The SD plug 174 is disposed outside of the cavity 153. The prongs 182 are configured to be received through the aperture 155 and within the cavity 153. The SD plug 174 includes a plunger 178 that engages with the flexible portion 156. When the SD plug 174 is received within the SD base 172 the plunger 178 pushes downwardly on the flexible portion 156 to push the conductive element 162 into the electrical receptacle 166. When the SD plug 174 is removed from the SD base 172, the bias of the flexible portion 156 pulls the conductive element 162 out of the electrical receptacles 166 to de-energize the circuitry 20. The service disconnect 170 and the interlock 160 may be configured such that the interlock 160 opens before the service disconnect opens when the SD plug 174 is removed from the SD base 172. Attaching the interlock to the cover prevents the user from energizing the circuitry 20 without the cover 152 attached to the tray 150. This may help prevent exposure of electrical potential to a user servicing the traction battery assembly 148.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A traction battery comprising:
a housing including a tray and a cover;
a plurality of battery components supported by the tray and enclosed by the cover;
a service disconnect base (SD base) disposed within the housing;
a circuit electrically connecting the components and the SD base;
an access panel for the housing, wherein the panel has a closed position and an open position; and
a service disconnect plug (SD plug) attached to the panel, wherein the SD plug connects circuitry within the SD base when the panel is in the closed position and wherein the SD plug is disconnected with the SD base when the panel is in the open position to open the circuit.

2. The traction battery of claim 1 further comprising a hinge connected to the housing and the access panel to pivotally attach the panel to the housing, wherein the access panel pivots at the hinge to move between the open and closed positions.

3. The traction battery of claim 1 wherein the access panel is slidably attached to the housing and wherein the access panel slides relative to the housing to move between the open and closed positions.

4. The traction battery of claim 1 wherein the cover is fastened to the tray and a fastener is disposed under the access panel such that the access panel must be moved to the open position in order to access the fastener and remove the cover.

5. The traction battery of claim 1 further comprising a vehicle high-voltage cable terminal disposed within the housing and electrically connected to the SD base, wherein the terminal is de-energized when the access panel is in the open position.

6. The traction battery of claim 5 further comprising a vehicle high-voltage cable connectable to the vehicle high-voltage cable terminal via a bolted connection.

7. The traction battery of claim 1 further comprising an interlock switch electrically connected with the circuit and including an interlock connector attached to the access panel and configured to be connected within an interlock receptacle disposed within the housing, wherein the interlock connector is disconnected with the interlock receptacle when the access panel is in the open position to open the circuit.

8. A traction battery comprising:
a housing including a cover having a service disconnect plug fixedly attached thereto;
a vehicle high-voltage cable disposed within the housing; and
a service disconnect base disposed within the housing, electrically connected to the cable via an electric circuit, and configured to receive the plug, wherein the cover, plug and base are arranged such that opening the cover opens the circuit and de-energizes the high-voltage cable.

9. The traction battery of claim 8 further comprising an interlock circuit electrically connected to the electric circuit and configured to open the electric circuit when the cover is opened.

10. The traction battery of claim 9 wherein the interlock circuit further comprises an interlock switch having an interlock connector disposed on the service disconnect plug and an interlock receptacle disposed on the service disconnect base.

11. The traction battery of claim 8 further comprising a terminal disposed within the housing and electrically connected with the electric circuit, wherein the vehicle high-voltage cable is connected to the terminal.

12. The traction battery of claim 11 wherein the terminal is a threaded stud and the vehicle high-voltage cable includes an eyelet received on the stud and secured to the stud with a nut.

13. A traction battery comprising:
a tray;
a battery cover cooperating with the tray to define a cavity and including a flexible portion;
circuitry including an electrical receptacle disposed within the cavity; and
a conductive element attached with the flexible portion and configured to engage the electrical receptacle when the flexible portion is pushed into the cavity.

14. The traction battery of claim 13 further comprising a plunger configured to engage with the flexible portion and push the flexible portion into the cavity.

15. The traction battery of claim 13 wherein the flexible portion is a spring member affixed with the cover and biased to sit substantially flush with the cover.

16. The traction battery of claim 13 wherein the circuitry includes a contactor for de-energizing the circuitry.

17. The traction battery of claim 16 wherein the electrical receptacle and the conductive element cooperate to form an interlock switch electrically connected with the contactor and wherein removal of the conductive element from the electrical receptacle opens the contactor and de-energizes the circuitry.

18. The traction battery of claim 17 further comprising a service disconnect plug including prongs receivable through the cover and engageable with a service disconnect base disposed within the cavity, wherein the service disconnect plug includes a plunger configured to engage with the flexible portion and push the flexible portion into the cavity when the service disconnect plug is received into the service disconnect base.

19. The traction battery of claim 18 wherein removal of the service disconnect plug from the service disconnect base opens the circuitry.

20. The traction battery of claim 17 wherein the electrical receptacle is disposed in the service disconnect base.
